(19) United States
(12) Patent Application Publication
(10) Pub. No.: US 2006/0082578 A1
(43) Pub. Date: Apr. 20, 2006

(54) Image processor, image processing method, and image processing program product

(75) Inventor: Eisaku Ohbuchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/249,352

(22) Filed: Oct. 14, 2005

(30) Foreign Application Priority Data
Oct. 15, 2004 (JP) 2004-302127

(51) Int. Cl. G06T 15/50; G06T 15/60

(52) U.S. Cl. 345/426

(57) ABSTRACT

To provide an image processor, an image processing method, and an image processing program, none of which require special hardware implementation and installation of a program requiring a large calculation amount. An embodiment of the present invention relates to an image processor for representing a shaded space defined by an object in a 3D space blocking light from a light source, which generates boundary data including positional information on the light source and positional information on the object to calculate the brightness of the shaded space based on the generated boundary data. With such a structure, the shaded space can be represented as boundary data in the same form as the object data, making it possible to reflect the brightness of the shaded space in a display image through the same processing as object rendering without any special hardware implantation, suppress a calculation amount, and improve an image quality.

### BACKGROUND OF THE INVENTION

1. Field of the Invention

The present invention relates to an image processor, an image processing method, and an image processing program product, and more particularly to an image processor, image processing method, and image processing program product for displaying a 3D image.

2. Description of Related Art

In the field of 3D computer graphics, there have been a variety of shading techniques based on information on a light source and an object. Among those, a typical one is a Z buffer method.

The Z buffer method is such that information about the distance from a view point to a display target is stored in a memory area called a Z buffer, and if some objects overlap, their distances are compared with reference to the Z buffer to display the object nearest to the view point on the screen. The Z buffer method requires more memory area for the Z buffer. However, because of its simple algorithm, the Z buffer method is easily implemented in hardware. Thus, the Z buffer method has been widely used.

By storing the distance from the light source set as the view point in the Z buffer based on the Z buffer method, it is determined that the objects other than the nearest one are shaded. In addition to this method, a technique for precisely defining the boundary of a shaded portion through anti-aliasing has been proposed (for example, see Japanese Unexamined Patent Publication No. 7-65199).

This method can precisely shade the object, but has a problem that a shaded portion in the space is not taken into consideration. In contrast, there has been proposed a technique of applying a special processing to a gaseous object such as clouds or fog using a dedicated hardware circuit (for example, see Japanese Unexamined Patent Publication No. 2001-188923). When this technique is applied to the shading portion in the space, it is possible to shade the object in the space.

However, a problem arises that such a method requires special hardware, thereby increasing costs. Further, if this method is implemented by software, a special processing is required, which means a larger calculation amount, resulting in high load on a processor.

### SUMMARY OF THE INVENTION

The present invention provides an image processor for representing a shaded space defined by an object blocking light from a light source in a 3D space. A rendering data storage part stores light source data including positional information on the light source and object data including positional information on the object. A boundary defining part generates boundary data including positional information on a boundary of the shaded space defined by the object blocking the light based on the light source data and the object data stored in the rendering data storage part. A boundary data storage part stores the boundary data generated with the boundary defining part. A shaded space rendering part generates brightness data on the shaded space based on the boundary data stored in the boundary data storage part.

According to the image processor, the shaded space can be represented as boundary data in the same form as the object data, making it possible to reflect the brightness of the shaded space in a display image through the same processing as object rendering without any special hardware implantation, suppress a calculation amount, and improve an image quality.

The present invention provides an image processing method for representing a shaded space defined by an object blocking light from a light source in a 3D space. The image processing method comprises generating boundary data including positional information on a boundary of the shaded space defined by the object blocking the light based on light source data including positional information on the light source and object data including positional information on the object, and generating brightness data on the shaded space based on the boundary data.

According to the image processing method, the shaded space can be represented as boundary data in the same form as the object data, making it possible to reflect the brightness of the shaded space in a display image through the same processing as object rendering without any special hardware implantation, suppress a calculation amount, and improve an image quality.

The present invention provides a computer program product causing a computer to execute image processing for representing a shaded space defined by an object blocking light from a light source in a 3D space. The image processing comprises generating boundary data including positional information on a boundary of the shaded space defined by the object blocking the light based on light source data including positional information on the light source and object data including positional information on the object, and generating brightness data on the shaded space based on the boundary data.

According to the image processing program product, the shaded space can be represented as boundary data in the same form as the object data, making it possible to reflect the brightness of the shaded space in a display image through the same processing as object rendering without any special hardware implantation, suppress a calculation amount, and improve an image quality.

According to the present invention, it is possible to provide an image processor, an image processing method, and an image processing program, none of which require special implantation in hardware, or installation of a program requiring a larger calculation amount.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the configuration of an image processor according to the present invention;

FIGS. 2A and 2B show an example of polygon data according to the present invention;

FIG. 3 shows an image data example according to the present invention;

FIG. 4 is a flowchart illustrative of a processing flow of an image processor according to the present invention;

FIG. 5 shows an example of shadow shaft data according to the present invention;

FIG. 6 is a flowchart showing a flow of generating shadow boundary data and shadow polygon data according to the present invention;

FIG. 7 shows how to detect shadow shaft data according to the present invention;

FIGS. 8A and 8B show images of shadow boundary data and shadow polygon data according to the present invention;

FIG. 9 shows how to generate shadow polygon data according to the present invention;

FIG. 10 shows a normal vector example at an intersection between a polygon of the object and a sight line vector;

FIGS. 11A and 11B are schematic diagrams of image data according to the present invention; and

FIG. 12 is a schematic diagram showing final image data according to the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

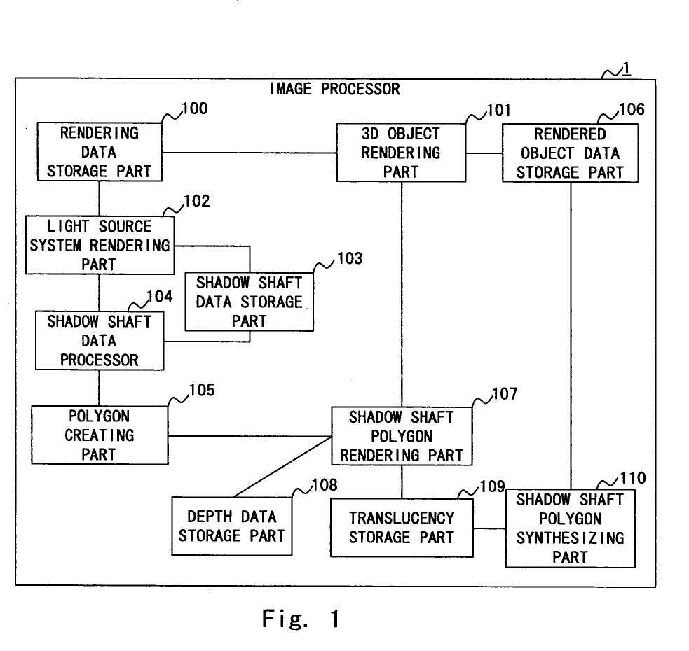

FIG. 1 is a block diagram showing the configuration of an image processor according to an embodiment of the present invention. An image processor 1 is implementable by means of a program in a computer-readable medium. The image processor 1 may be incorporated in, for example, PC (personal computer), a cell phone, or other special devices. The image processor 1 includes a rendering data storage part 100, a 3D object rendering part 101, a light source system rendering part 102, a shadow shaft data storage part 103, a shadow shaft data processor 104, a polygon creating part 105, a rendered object data storage part 106, a shadow shaft polygon rendering part 107, a depth data storage part 108, a translucency storage part 109, and a shadow shaft polygon synthesizing part 110.

The 3D object rendering part 101, the light source system rendering part 102, the shadow shaft data processor 104, the polygon creating part 105, the shadow shaft polygon rendering part 107, and the shadow shaft polygon synthesizing part 110 are implemented by a CPU (central processing unit) or other such processors executing various processings based on programs. At this time, the various processors may be provided with CPUs in a one-to-one correspondence. Alternatively, a single CPU may take on all processings.

The rendering data storage part 100, the shadow shaft data storage part 103, the rendered object data storage part 106, the depth data storage part 108, and the translucency storage part 109 store various types of data in a writable/readable storage device such as a RAM (random access memory). If necessary, a storage device such as an HDD (hard disk drive) may be used. At this time, data that is sharable between the storage parts may be store at the same location for saving the memory capacity.

Next, the respective processors and storage parts are described in detail. The rendering data storage part 100 stores data for image formation. Examples of the data to be stored include object data, light source data, and view point data. The object data is information about a target object, which includes polygon data. The polygon data is used for approximating the object with polygons, which includes vertex data and polygon constituent data.

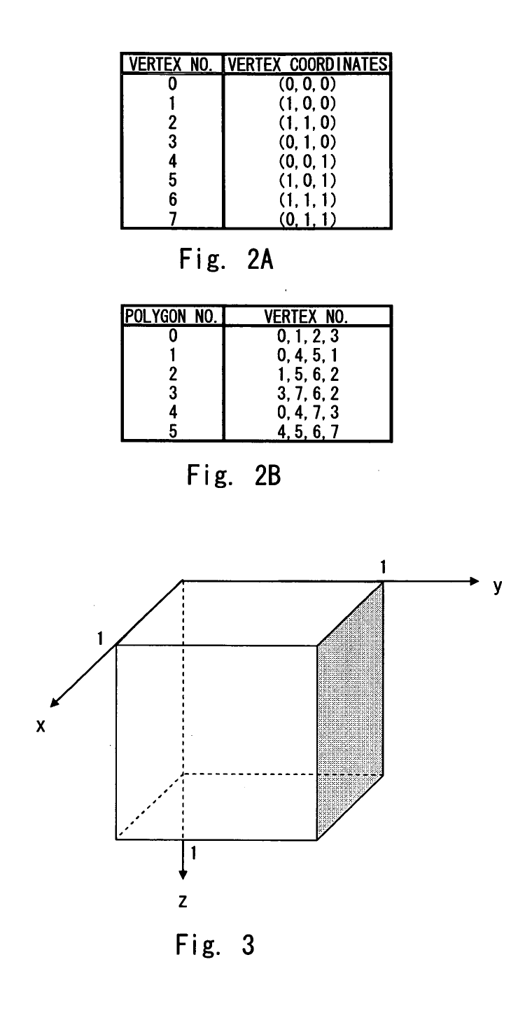

The polygon data is explained in brief. FIGS. 2A and 2B show an example of the polygon data. FIG. 2A shows the vertex data, and FIG. 2B shows the polygon constituent data. As shown in FIG. 2A, as the vertex data, the coordinates of each vertex are stored in association with the vertex number as identification information assigned to each vertex. In this example, 8 vertices are illustrated with the coordinates of (0, 0, 0), (1, 0, 0), (1, 1, 0), (0, 1, 0), (0, 0, 1), (1, 0, 1), (1, 1, 1), and (0, 1, 1).

As regards the polygon constituent data of FIG. 2B, the vertex coordinates of each polygon are stored in association with the polygon number as identification information assigned to each polygon. In this example, 6 polygons are illustrated. The polygon numbered 0 has four vertices numbered 0, 1, 2, and 3. In other words, this polygon is four-cornered rectangle with the coordinates of (0, 0, 0), (1, 0, 0), (1, 1, 0), and (0, 1, 0). FIG. 3 shows the six polygons rendered on the 3D coordinate system. In other words, the polygon data of FIGS. 2A and 2B represent a cube.

The 3D object rendering part 101 generates image data to be displayed on the screen based on the data stored in the rendering data storage part 100. For example, if the data as shown in FIGS. 2A and 2B is stored in the rendering data storage part 100, the image data shown in FIG. 3 is generated. The generated data is stored in the rendered object data storage part 106.

The light source system rendering part 102 generates shadow shaft data based on the received light source positional data and object data. The shadow shaft data is obtained by rendering the image with the light source position set as a view point and associating the generated image data with the object identification information and information on the distance from the light source. The shadow shaft data is used for representing the shaded space. The generated shadow shaft data is stored in the shadow shaft data storage part 103. The shadow shaft data storage part 103 stores shadow the shaft data generated with the light source system rendering part 102. The shadow shaft data processor 104 uses the stored shadow shaft data.

The shadow shaft data processor 104 receives the shadow shaft data generated with the light source system rendering part 102 from the shadow shaft data storage part 103 to generate shadow boundary data. The generated shadow boundary data is sent to the polygon creating part 105. The polygon creating part 105 is a boundary defining part, which generates shadow polygon data as boundary data based on the shadow boundary data supplied from the shadow shaft data processor 104. The generated shadow polygon data is sent to the shadow shaft polygon rendering part 107.

The rendered object data storage part 106 stores image data generated with the 3D object rendering part 101. The stored image data is synchronized by the shadow shaft polygon synthesizing part 110 to complete the display image data. The shadow shaft polygon rendering part 107 determines the translucency at the shadow shaft polygon positions based on the shadow shaft polygon data received from the polygon creating part 105. In the determination process, the depth data is also generated and used for determining the translucency. The determined translucency is stored in the translucency storage part 109 as translucency data and then sent to the shadow shaft polygon synthesizing part 110.

The depth data storage part 108 stores the depth data generated with the shadow shaft polygon rendering part 107. The depth data is used for the shadow shaft polygon rendering part 107 to determine the translucency. The translucency storage part 109 stores the translucency data generated with the shadow shaft polygon rendering part 107. The stored translucency data is sent to the shadow shaft polygon synthesizing part 110 to obtain final image data reflecting the translucency data.

The shadow shaft polygon synthesizing part 110 generates final image data by reflecting the translucency data received from the translucency storage part 109 on the image data supplied from the rendered object data storage part 106. The thus-generated final image data is output and displayed on the display or the like.

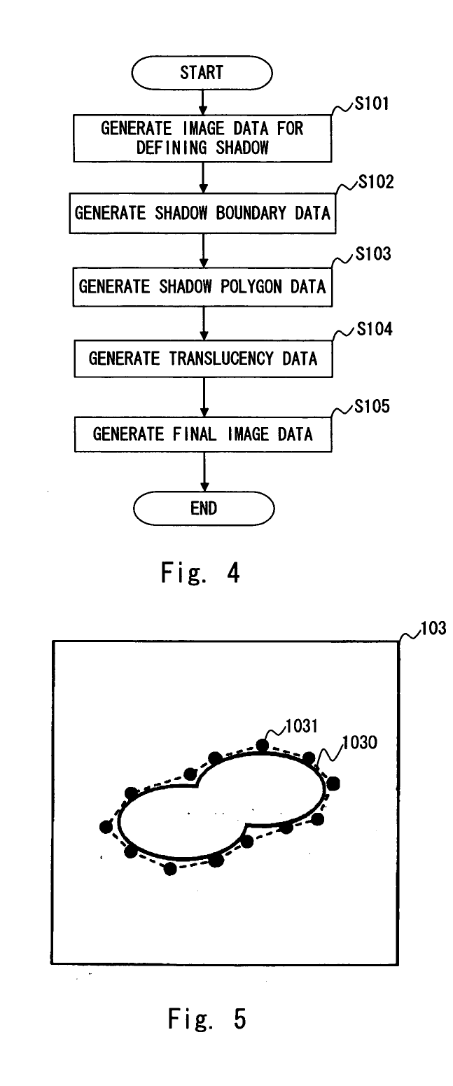

Referring next to a flowchart of FIG. 4, the processing flow of the image processor 1 according to the embodiment of the present invention is described. First of all, the light source system rendering part 102 executes a light source system rendering processing using the received object data and the light source data to generate shadow shaft data (S101).

How to generate the shadow shaft data is detailed hereinbelow. The input object data is polygon data, and the light source data includes coordinate data on a light source. The light source data may include color or brightness information besides the coordinate data on the light source, but such information is not used herein. The light source system rendering part 102 renders the object as viewed from the light source the coordinates of which are set as the coordinates of the view point. The image data generated through the rendering composes the shadow shaft data used for defining the shadow.

FIG. 5 shows an image data example generated through the rendering. In the illustrated example, data on an object 1030 as viewed from the light source is stored as the image data. Further, it is possible to detect a vertex 1031 of the shadow polygon data from the boundary of the object 1030. How to detect the vertex and generate the shadow polygon data is discussed later in detail. At this time, the light source system rendering part 102 stores the image data associated with the object identification information and the information on the distance from the light source, as the shadow shaft data in the shadow shaft data storage part 103.

Next, the shadow shaft data processor 104 generates shadow boundary data based on the image data of the shadow shaft data, the associated object identification information and the associated information on the distance from the light source stored in shadow shaft data storage part 103 (S102). How to generate the shadow boundary data is described later in more detail. The shadow shaft data processor 104 sends the generated shadow boundary data to the polygon creating part 105.

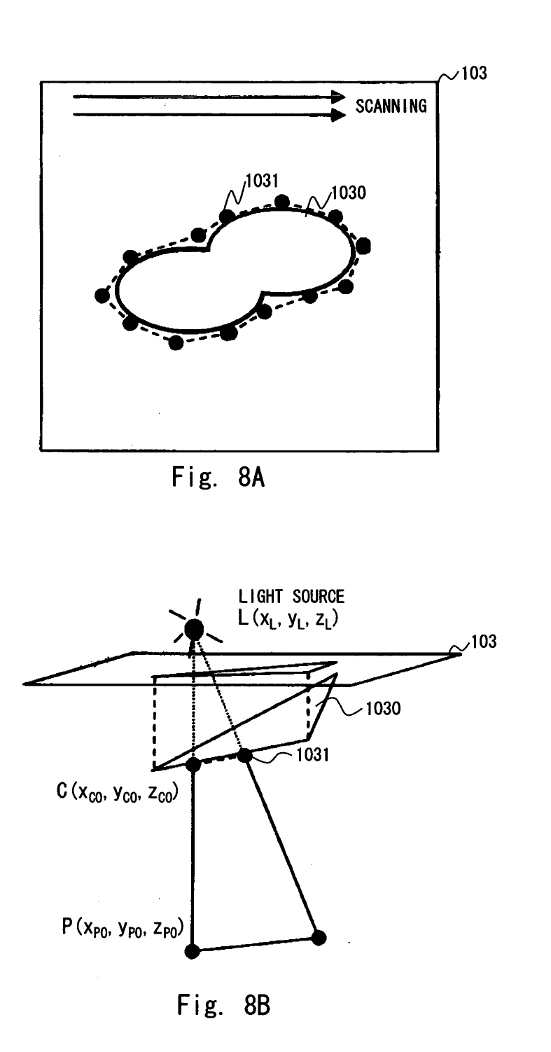

The polygon creating part 105 generates shadow polygon data based on the shadow boundary data supplied from the shadow shaft data processor 104 (S103). FIG. 8A shows the shadow boundary data. Every two vertices 1031 on the boundary of the object 1030 of FIG. 8A are paired for generating the shadow polygon data. FIG. 8B shows an image of the shadow polygon data based on the points (vertices) of the shadow boundary data. The polygon creating part 105 determines, by calculation, points P of the shadow polygon data based on the coordinates of points C 1031 of the shadow boundary data and the coordinates of the light source L as shown in FIG. 8B. A pair of points C and corresponding pair of points P, that is, four points in total, constitute the polygon data.

The polygon creating part 105 generates shadow polygon data for all shadow boundary data supplied from the shadow shaft data processor 104. The generated shadow polygon data is boundary data (boundary surface data) on the boundary between the object and the shaded space. After having generated the shadow polygon data, the polygon creating part 105 sends the generated shadow polygon data to the shadow shaft polygon rendering part 107. The shadow shaft polygon rendering part 107 generates the translucency data as data about brightness of the shaded space based on the received shadow polygon data (S104). How to generate the translucency data is detailed later. The brightness of the object is determined in the display image based on the translucency data.

The processing of the image processor 1 is ended with the generation of the final image data (S105). The image data is output and displayed as an image on a display device.

Through the determination of the brightness of the shaded space by calculation in this way, the image data reflecting the brightness of the shaded space can be generated with no special implementation in hardware, nor installation of a program requiring a larger calculation amount. This method is particularly effective for reducing a cost for hardware implantation or load on a processor due to the complicated computation.

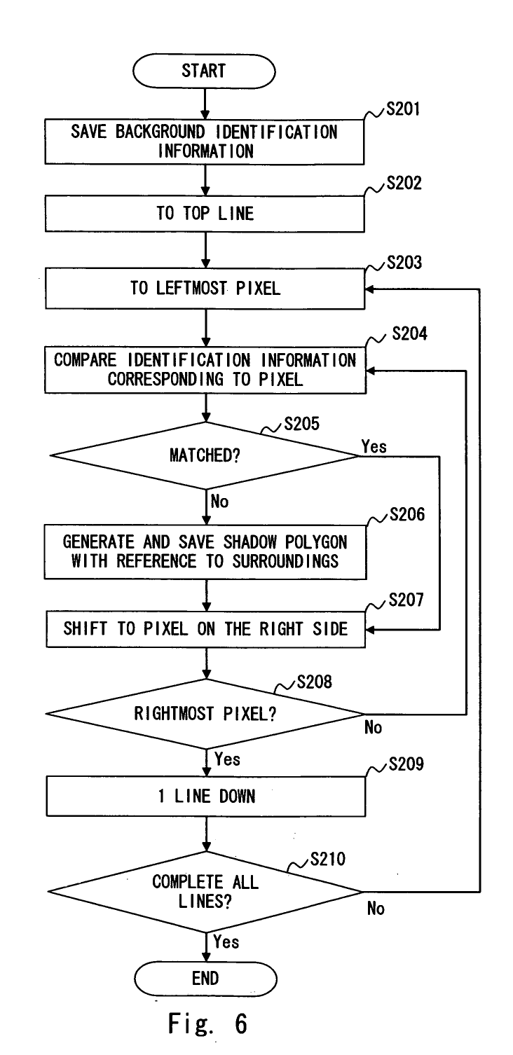

How to generate the shadow boundary data is detailed hereinbelow. FIG. 6 is a flowchart showing a flow of generating the shadow boundary data and the shadow polygon data according to the present invention. The shadow shaft data processor 104 first detects the shadow shaft data stored in the shadow shaft data storage part 103. The shadow shaft data contains the object identification information in association with each pixel, thereby making it possible to detect a pixel with the object identification information.

First, the shadow shaft data processor 104 saves the background identification information (S201). This is because the top pixel has no identification information to be compared. The detection starts from the top line of the shadow shaft data (S202), and starts from the leftmost pixel (S203) and proceeds rightward pixel by pixel (S204).

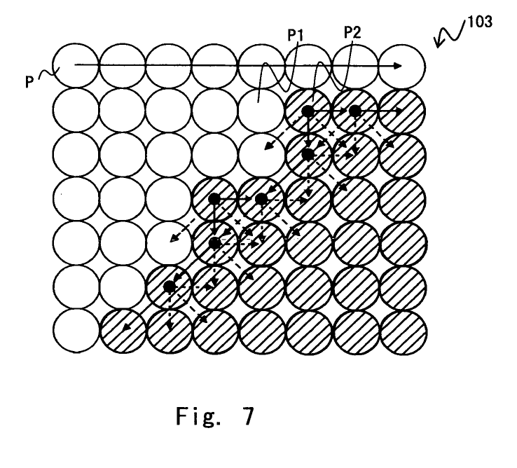

The detection is carried out as follows. The shadow shaft data processor 104 compares the object identification information corresponding to image data of the pixel with the previously saved object identification information. If the identification information are not matched as a result of comparison (S205), the pixel is determined as a boundary point. FIG. 7 shows a method of detecting shadow shaft data. The image data in the shadow shaft data is composed of pixels P. In this case, a pixel P1 is the last pixel the object identification information of which matches with the previously saved one. The pixel P2 and subsequent pixels have identification information different from the previously saved object identification information. In this case, the shadow shaft data processor 104 examines the identification information of the pixels in the “rightward direction”, “the direction sloping down to the right”, “downward direction” or “the direction sloping down to the left” with respect to the pixel concerned to thereby determine a pixel paired with this pixel (S206). The detection starts with the leftmost pixel on the top line, so the examination in the other directions may be omitted.

After the pixel has been determined, or the identification information have been matched as a result of comparison, the processing is shifted to a pixel on the right side of the previous one (S207) to make a comparison therebetween again. After the detection for one line has been completed (S208), the processing is shifted to a lower line (S209), and the detection is started from the leftmost pixel and proceeds in the right direction again.

The shadow shaft data processor 104 executes this processing on all pixels (S210), and sends coordinate data about all of the detected pixel pairs as shadow boundary data to the polygon creating part 105. At this time, the shadow boundary data may be sent to the polygon creating part 105 each time a pixel pair is found or after the detection has been completed for all the pixels.

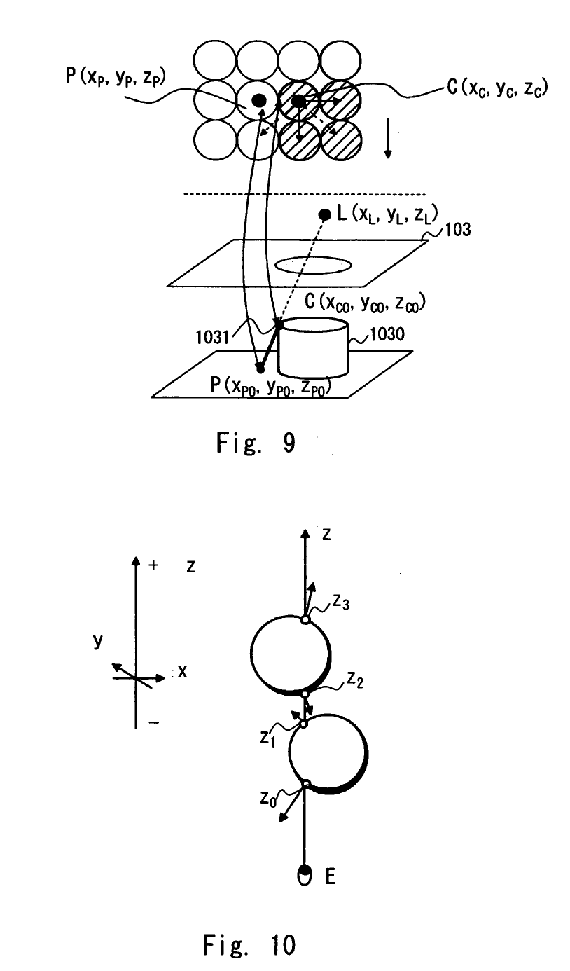

From now on, how to generate the shadow polygon data is detailed. As shown in FIG. 9, the light source is defined as L(x₁,y₁,z₁), and the boundary point 1031 of the object 1030 in the shadow shaft data storage part 103, which is generated by rendering the image from the light source is defined as C(x_{c0},y_{c0},z_{c0}).The polygon creating part 105 determines a point (xₚ₀,yₚ₀,zₚ₀) on the line extending from each point C of the shadow boundary data. The z coordinate of the point P can be derived from the information about the distance from the light source. Hence, the polygon creating part 105 determines the x coordinate and the y coordinate based on the distance ratio. This is represented by Numerical Expression 1.

$$P = ( \begin{matrix}{x}_{po} \\ {y}_{po}\end{matrix} ) = \frac{{z}_{po} - {z}_{L}}{{z}_{co} - {z}_{L}} \{ ( \begin{matrix}{x}_{co} \\ {y}_{co}\end{matrix} ) - ( \begin{matrix}{x}_{L} \\ {y}_{L}\end{matrix} ) \} + ( \begin{matrix}{x}_{L} \\ {y}_{L}\end{matrix} )$$

A pair of points of the shadow boundary data and a pair of points on the line extending from the above pair, i.e., four points in total serve as the vertices of the shadow polygon data.

How to generate the translucency data is described in detail. First, the shadow shaft polygon rendering part 107 performs rendering on the shadow polygon data as viewed from the view point. Next, the shadow shaft polygon rendering part 107 calculates the depth based on the shadow polygon data. This depth calculation is carried out as follows. First, the direction extending from the view point is defined as a Z direction. Next, the shadow shaft polygon rendering part 107 detects a polygon crossing the Z direction extending from the view point (sight line vector). Thereafter, the shadow shaft polygon rendering part 107 calculates the normal vector of the detected each polygon. The polygon has data on at least three vertices. Thus, the vector normal to the vectors of two different sides can be calculated. This vector is used as the normal vector of the polygon.

The shadow shaft polygon rendering part 107 repeats the above processing for all the polygons the sight line vector crosses to determine the normal vectors. After the normal vector has been determined, the shadow shaft polygon rendering part 107 calculates the Z-directional components of the normal vector. The Z direction implies the sight line direction as described above. The shadow shaft polygon rendering part 107 stores the obtained Z-directional components in the depth data storage part 108. After all the Z-directional components were obtained, the shadow shaft polygon rendering part 107 generates the translucency data based on the components to store the data in the translucency storage part 109.

FIG. 10 shows an example of the normal vector at a crossing point between the polygon forming the object and the sight line vector. In the illustrated example of FIG. 10, the sight line vector extending from the view point E to the object crosses the polygon forming the object at four positions z₀, z₁, z₂, and z₃, and the normal vectors at each position are as shown in FIG. 10.

At this time, the shadow shaft polygon rendering part 107 calculates the four normal vectors to add all the Z-directional components thereof. In this case, as represented by the normal vectors at the positions z₀ and z₂, the Z-directional component may take either a positive value or a negative value depending on the directions of the sight line vector and the normal vector. If the component takes a negative value, this negative value is added. In short, as for the negative value, the subtraction is carried out in practice. Upon the completion of the addition, the shadow shaft polygon rendering part 107 substitutes the value into a predetermined expression to thereby obtain the final value of the translucency.

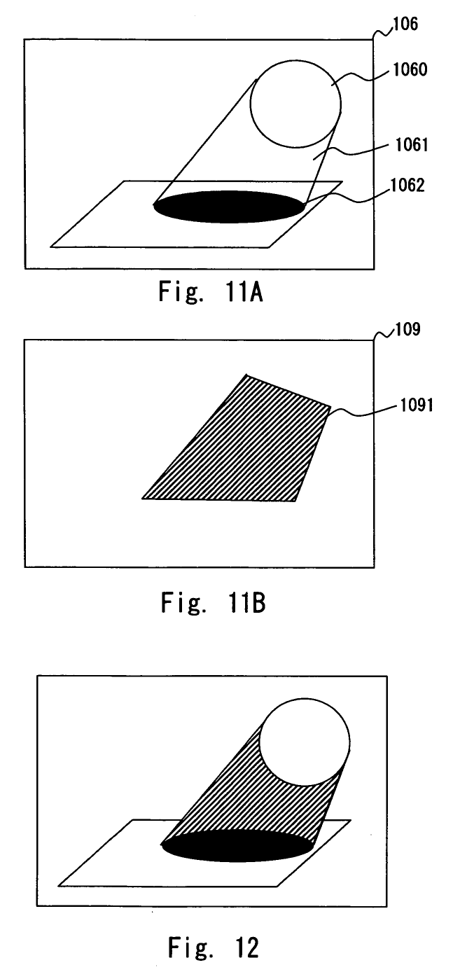

After the shadow shaft polygon rendering part 107 has calculated all the values of translucency, the translucency data is completed. The following description is directed to the case where the 3D object rendering part 101 renders an image as shown in FIG. 11A. In this image data, the shaded space 1061 is between the object 1060 and the projected shadow 1062. The value of translucency is applied to the brightness of the shaded space 1061 which does not vary in the general rendering process. The translucency data is a translucency value of a portion 1091 corresponding to a shadow portion 1061 of FIG. 11A as shown in FIG. 11B. The translucency data includes translucency values for each pixel like the image data. Alternatively, the translucency data may include area information and translucency corresponding to the area information like “the shadow portion 1091 of FIG. 11B has the translucency of 0.7”. However, FIG. 11B is a schematic diagram, so the translucency of the shaded space is not necessarily uniform in practice.

After the shadow shaft polygon rendering part 107 has generated the translucency data, the shadow shaft polygon synthesizing part 110 reflects the translucency data supplied from the translucency data storage part 109 in the image data from the rendered object data storage part 106 to complete the image data. The rendered object data storage part 106 stores image data rendered with the 3D object rendering part 101. The final image data is generated by integrating the image data from the rendered object data storage part 106 with the transmittancy of the translucency data from the translucency storage part 109. The transmittancy before updating is represented by C_{old}, the updated transmittancy is represented by C_{new}, and the translucency is represented by α, the calculation is carried out based on Numerical Expression 2 below.
C_{new}=α·C_{old}

At this time, components of Red, Green, and Blue are independently calculated. With desired settings, values of translucency are changed for the respective components of Red, Green, and Blue, by which a colored shadow can be created using a color light source as well as a while light source. FIG. 12 shows final image data.

In the above example, the boundary is set as a four-sided polygon, but may be set as a three-sided polygon, or five or more sided polygon. Further, a curved polygon may be used instead.

It is apparent that the present invention is not limited to the above embodiment and it may be modified and changed without departing from the scope and spirit of the invention.

What is claimed is:

1. An image processor for representing a shaded space defined by an object blocking light from a light source in a 3D space, comprising:
a rendering data storage part storing light source data including positional information on the light source, and object data including positional information on the object;
a boundary defining part generating boundary data including positional information on a boundary of the shaded space defined by the object blocking the light, based on the light source data and the object data stored in the rendering data storage part;
a boundary data storage part storing the boundary data generated with the boundary defining part; and
a shaded space rendering part generating brightness data on the shaded space based on the boundary data stored in the boundary data storage part.

2. The image processor according to claim 1, wherein the boundary defining part includes:
a light source system rendering part generating image data on the object as viewed from a light source position based on the object data, the light source position being derived from the light source data stored in the rendering data storage part, and;
a shadow shaft data storage part storing the image data generated with the light source system rendering part, in association with information on a distance from the light source to the object and identification information for identifying the object; and
a boundary position information generating part obtaining, by calculation, positional information on the boundary of the shaded space defined by the object blocking the light, based on the image data stored in the shadow shaft data storage part, the distance information and the identification information.

3. The image processor according to claim 1, wherein the object data and the boundary data each include at least one polygon data.

4. The image processor according to claim 1, wherein the shaded space rendering part calculates a normal vector of each polygon based on polygon data of the boundary data to generate the brightness data on the shaded space, based on a sight line direction component of the normal vector.

5. An image processing method for representing a shaded space defined by an object blocking light from a light source in a 3D space, comprising:
generating boundary data including positional information on a boundary of the shaded space defined by the object blocking the light, based on light source data including positional information on the light source and object data including positional information on the object; and
generating brightness data on the shaded space based on the boundary data.

6. The image processing method according to claim 5, wherein the generating of the boundary data includes:
generating image data on the object as viewed from a light source position based on the object data, the light source position being derived from the positional information on the light source in the light source data;
storing the generated image data in association with information on a distance from the light source to the object and identification information for identifying the object; and
obtaining, by calculation, positional information on the boundary of the shaded space defined by the object blocking the light, based on the stored image data, the distance information and the identification information.

7. The image processing method according to claim 5, wherein the object data and the boundary data each include at least one polygon data.

8. The image processing method according to claim 5, wherein the generating of the brightness data on the shaded, space includes calculating a normal vector of each polygon based on polygon data of the boundary data based on a sight line direction component of the normal vector to generate the brightness data on the shaded space.

9. A computer program product, in a computer-readable medium, causing a computer to execute image processing for representing a shaded space defined by an object blocking light from a light source in a 3D space, the image processing comprising:
generating boundary data including positional information on a boundary of the shaded space defined by the object blocking the light, based on light source data including positional information on the light source and object data including positional information on the object; and
generating brightness data on the shaded space based on the boundary data.

10. The computer program product according to claim 9, wherein the generating of the boundary data includes:
generating image data on the object as viewed from a light source position based on the object data, the light source position being derived from the positional information on the light source in the light source data;
storing the generated image data in association with information on a distance from the light source to the object and identification information for identifying the object; and
obtaining, by calculation, positional information on the boundary of the shaded space defined by the object blocking the light, based on the stored image data, the distance information and the identification information.

11. The image processing program product according to claim 9, wherein the object data and the boundary data each include at least one polygon data.

12. The image processing program product according to claim 9, wherein the generating of the brightness data on the shaded space includes calculating a normal vector of each polygon based on polygon data composing the boundary data based on a sight line direction component of the normal vector to generate the brightness data on the shaded space.
